(19) United States
(12) Patent Application Publication
(10) Pub. No.: US 2026/0190204 A1
(43) Pub. Date: Jul. 2, 2026

(54) CEILING FAN WITH LIGHT SOURCE AND CONTROL CIRCUIT FOR THE SAME

(71) Applicant: Fanxion LLC, Austin, TX (US)

(72) Inventor: Semi Tang, Austin, TX (US)

(21) Appl. No.: 19/006,372

(22) Filed: Dec. 31, 2024

(51) Int. Cl. H05B 47/17; H02P 23/14; H05B 47/185

(52) U.S. Cl. CPC H05B 47/17; H02P 23/14; H05B 47/185

(57) ABSTRACT

The present disclosure relates to a ceiling fan with light source and a control circuit for the same. The control circuit includes a first detection unit, a second detection unit, a first control unit, and a second control unit. The first detection unit is connected with a first power supply line of the fan motor, and send a first detection signal when detecting that the first power supply line is in the connected state. The second detection unit is connected with a second power supply line of the light source, and sends a second detection signal when detecting that the second power supply line is in the connected state. The first control unit receives the first detection signal and starts the fan motor to. The second control unit receives the second detection signal and activates the light source.

### TECHNICAL FIELD

The present disclosure belongs to the field of control circuits, and more particularly relates to a ceiling fan with light source and a control circuit for the same.

### BACKGROUND ART

In conventional control systems for a ceiling fan with light source, a single microprocessor control unit (MCU) is typically employed to control the operating state of the fan motor and the light source. The MCU determines whether to activate the fan motor and the light source according to the last operating state recorded. When a user connects the power supply of the ceiling fan with light source, the MCU activates the ceiling fan with light source to operate according to the previous operating state. However, this control method has operational limitations, which cannot meet the need to start the ceiling fan with light source immediately when the power supply of the ceiling fan with light source is connected without relying on the recorded operating state.

### SUMMARY

In order to at least alleviate at least one of the technical problems in the prior art, the present disclosure provides a ceiling fan with light source and a control circuit for the same, which can be started quickly without a remote controller when the power supply is connected.

According to a first aspect of the present disclosure, a control circuit of a ceiling fan with light source is provided. The control circuit includes: a first detection unit, which is connected with a first power supply line of a fan motor of the ceiling fan with light source, and is configured to send a first detection signal in response to a detection that the first power supply line is switched from a disconnected state to a connected state; a second detection unit, which is connected with a second power supply line of a light source of the ceiling fan with light source, and is configured to send a second detection signal in response to detection that the second power supply line is switched from a disconnected state to a connected state; a first control unit, which is connected with the first detection unit and the fan motor respectively, and is configured to receive the first detection signal and to activate the fan motor; and a second control unit, which is connected with the second detection unit and the light source respectively, and is configured to receive the second detection signal and to activate the light source.

According to some embodiments of the first aspect of the present disclosure, the first control unit includes a first MCU and a motor driving unit. The first MCU is connected with the motor driving unit. The motor driving unit is connected with the fan motor.

According to some embodiments of the first aspect of the present disclosure, the second control unit includes a second MCU and a light source driving unit. The second MCU is connected with the light source driving unit. The light source driving unit is connected with the light source.

According to some embodiments of the first aspect of the present disclosure, the first power line is provided with a motor power supply unit. The motor power supply unit is respectively connected with the first MCU and the motor driving unit.

According to some embodiments of the first aspect of the present disclosure, the second power supply line is provided with a light source power supply unit. The light source power supply unit is respectively connected with the second MCU and the light source driving unit.

According to some embodiments of the first aspect of the present disclosure, the first MCU and the second MCU are connected through a communication interface.

According to some embodiments of the first aspect of the present disclosure, the control circuit further includes a receiver that is connected with the first MCU and the second MCU respectively. The receiver is further in communicative connection with a transmitter, and is configured to receive data sent by the transmitter.

According to some embodiments of the first aspect of the present disclosure, the control circuit further includes a first memory connected with the first MCU. The first memory is configured to store information about an operating state of the fan motor.

In some embodiments of the present disclosure, the control circuit further includes a second memory that is connected with the second MCU. The second memory is configured to store information about an operating state of the light source.

According to an embodiment of the second aspect of the present disclosure, a ceiling fan with light source is provided. The ceiling fan with light source includes a fan switch, a light source switch, a fan motor, a light source, and a control circuit of the ceiling fan with light source according to an embodiment of the first aspect of the present disclosure. The fan switch is connected with a first power supply line of the control circuit. The light source switch is connected with a second power supply line of the control circuit. The fan motor is connected with a first control unit of the control circuit. The light source is connected with a second control unit of the control circuit.

The present disclosure has the advantages that two independent control units are arranged to control the fan motor and the light source respectively. The first detection unit is configured to detect the power signal of the first power supply line of the fan motor in real time. The second detection unit is configured to detect the power signal of the second power supply line of the light source in real time. When a user operates the fan switch to turn on the fan, the first power supply line is switched from the disconnected state to the connected state. When detecting that first power supply line is switched from the disconnected state to the connected state, the first detection unit sends a first detection signal to the first control unit. The first control unit receives the first detection signal and activates the fan motor. When a user operates the fan switch to turn on the light source, the second power supply line is switched from the disconnected state to the connected state. When detecting that second power supply line is switched from the disconnected state to the connected state, the second detection unit sends a second detection signal to the second control unit. The second control unit receives the second detection signal and activates the light source. Through the control circuit of the ceiling fan with light source, the user is allowed to activate the light source by simply operating the light source switch set on a wall, or to activate the fan by simply operating the fan switch set on the wall, without looking for a remote controller for additional operation, thus reducing the user's dependence on the remote controller and improving the convenience and experience of the ceiling fan with light source for the user.

In addition, additional aspects and advantages of the present disclosure will be set forth in part in the following description, and in part will be apparent from the description which follows, or may be learned by practice of the present disclosure.

### DESCRIPTION OF DRAWINGS

FIG. 1 depicts a block diagram showing a control circuit of a ceiling fan with light source according to an embodiment of the present disclosure;

FIG. 2 depicts a block diagram of a ceiling fan with light source according to an embodiment of the present disclosure;

FIG. 3 depicts an equivalent block diagram of the ceiling fan with light source according to an embodiment of the disclosure;

FIG. 4 depicts a circuit diagram showing a second detection unit, a motor power supply unit and a light source power supply unit according to an embodiment of the present disclosure;

FIG. 5 depicts a circuit diagram showing a first detection unit according to an embodiment of the present disclosure;

FIG. 6 depicts a circuit diagram showing a first MCU according to an embodiment of the present disclosure;

FIG. 7 depicts a circuit diagram showing a second MCU according to an embodiment of the present disclosure;

FIGS. 8 and 9 each depicts a circuit diagram showing a current amplifying unit of a first power supply line according to an embodiment of the present disclosure;

FIG. 10 depicts a circuit diagram showing a motor driving unit according to an embodiment of the present disclosure;

FIG. 11 depicts a circuit diagram showing a light source driving unit according to an embodiment of the present disclosure;

FIG. 12 depicts a circuit diagram of a light source switch according to an embodiment of the present disclosure;

FIG. 13 depicts a circuit diagram showing a fan switch according to an embodiment of the present disclosure;

FIG. 14 depicts a circuit diagram showing a buzzer unit according to an embodiment of the present disclosure; and

FIG. 15 depicts a circuit diagram showing a voltage sampling circuit according to an embodiment of the present disclosure.

### DETAILED DESCRIPTION

In the following, the concept, specific structure and technical effects of the present disclosure will be described in conjunction with examples and drawings. The embodiments in this application and the features in the embodiments can be combined with each other without conflict.

When a feature is described as “fixed” or “connected” to another feature, it can be directly fixed or connected to another feature, or indirectly fixed or connected to another feature. In addition, the descriptions of “up”, “down”, “left”, “right”, “top” and “bottom” used in the present disclosure are only relative to the mutual positional relationship with respect to the elements in the drawings.

In addition, unless otherwise defined, all technical and scientific terms used herein have the same meaning as commonly understood by those skilled in the art. The terminology used in this description is intended to illustrate rather than limiting the specific embodiments of the present disclosure. As used herein, the term “and/or” includes any combination of one or more related listed items.

In the existing control system of a ceiling fan with light source, a single microcontroller (MCU) is typically employed to control the operating state of the fan motor and the light source. The microcontroller determines whether to activate the fan motor and the light source according to the last operating state recorded. When a user connects the power supply of the ceiling fan with light source, the microcontroller activates the ceiling fan with light source to operate according to the previous operating state. However, this control method has operational limitations, which cannot meet the need to start the ceiling fan with light source immediately when the power supply of the ceiling fan with light source is connected without relying on the recorded operating state.

In view of this, some embodiments of the present disclosure provide a ceiling fan with light source and a control circuit for the same.

Several embodiments of the present disclosure will be further illustrated with reference to the drawings.

FIG. 2 depicts a block diagram showing a circuit of a ceiling fan with light source. In an embodiment of the present disclosure, the ceiling fan with light source includes a fan switch, a light source switch, a fan motor, a light source, and a control circuit of the ceiling fan with light source. The fan switch is connected with a first power supply line of the control circuit for the ceiling fan with light source. The light source switch is connected with a second power supply line of the control circuit of the ceiling fan with light source. The fan motor is connected with a first control unit of the control circuit of the ceiling fan with light source. The light source is connected with a second control unit of the control circuit of the ceiling fan with light source.

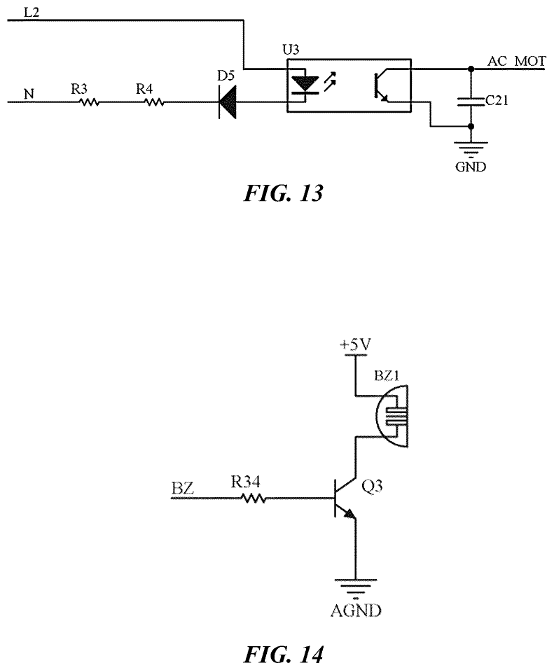

FIG. 12 depicts a circuit diagram of a light switch. FIG. 13 depicts a circuit diagram of a fan switch.

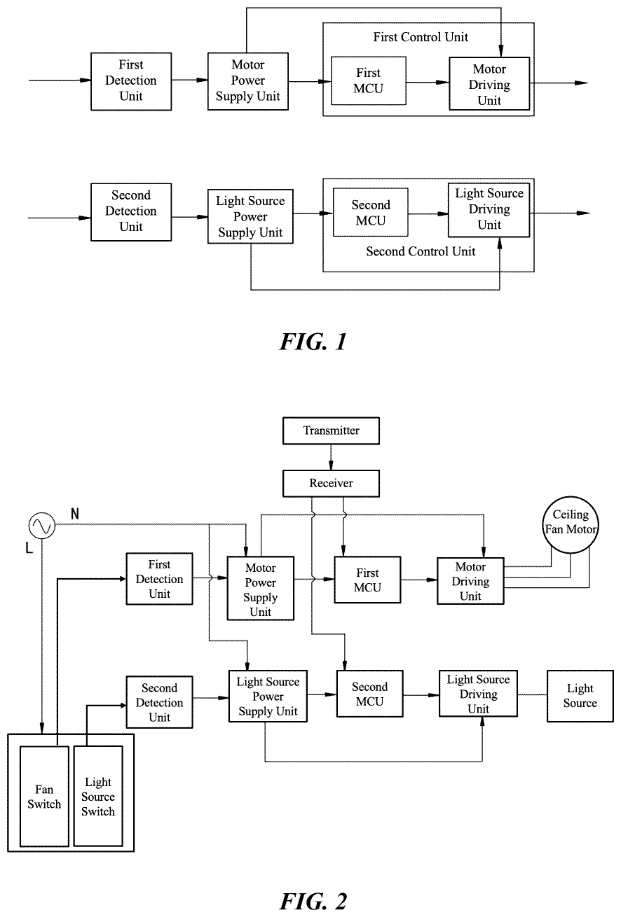

FIG. 1 depicts a block diagram showing a control circuit of a ceiling fan with light source. In an embodiment of the present disclosure, the control circuit of the ceiling fan with light source includes a first detection unit, a second detection unit, a first control unit, and a second control unit.

In particular, the first detection unit is connected with a first power supply line of a fan motor of the ceiling fan with light source, and is configured to send a first detection signal when detecting that the first power supply line is switched from a disconnected state to a connected state. The second detection unit is connected with a second power supply line of the light source of the ceiling fan with light source, and is configured to send a second detection signal when detecting that the second power supply line is switched from a disconnected state to a connected state. The first control unit is connected with the first detection unit and the fan motor respectively, and is configured to receive the first detection signal and to activate the fan motor. The second control unit is connected with the second detection unit and the light source respectively, and is configured to receive the second detection signal and to activate the light source.

In this embodiment, two independent control units are set to control the fan motor and the light source respectively. The first detection unit is configured to detect the power signal of the first power supply line of the fan motor in real time. The second detection unit is configured to detect the power signal of the second power supply line of the light source in real time. When a user operates the fan switch to turn on the fan, the first power supply line is switched from the disconnected state to the connected state. When detecting that first power supply line is switched from the disconnected state to the connected state, the first detection unit sends a first detection signal to the first control unit. The first control unit receives the first detection signal and activates the fan motor. When a user operates the fan switch to turn on the light source, the second power supply line is switched from the disconnected state to the connected state. When detecting that second power supply line is switched from the disconnected state to the connected state, the second detection unit sends a second detection signal to the second control unit. The second control unit receives the second detection signal and activates the light source.

Through the control circuit of the ceiling fan with light source, the user is allowed to activate the light source by simply operating the light source switch set on a wall, or to activate the fan by simply operating the fan switch set on the wall, without looking for a remote controller for additional operation, thus reducing the user's dependence on the remote controller and improving the convenience and user experience of the ceiling fan with light source.

When the ceiling fan with light source fails or specific operation instructions need to be fed back to the user, the buzzer of the alarm unit buzzes to give a prompt sound. FIG. 14 depicts a circuit diagram of a buzzer unit.

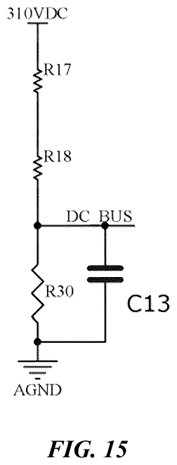

FIG. 15 depicts a circuit diagram of a voltage sampling circuit. The line voltage is detected by the voltage sampling circuit, such that the microcontroller can judge the operating voltage, adapt to the use environment under the voltage of 120V or 240V, and perform the function of over-voltage protection (OVP).

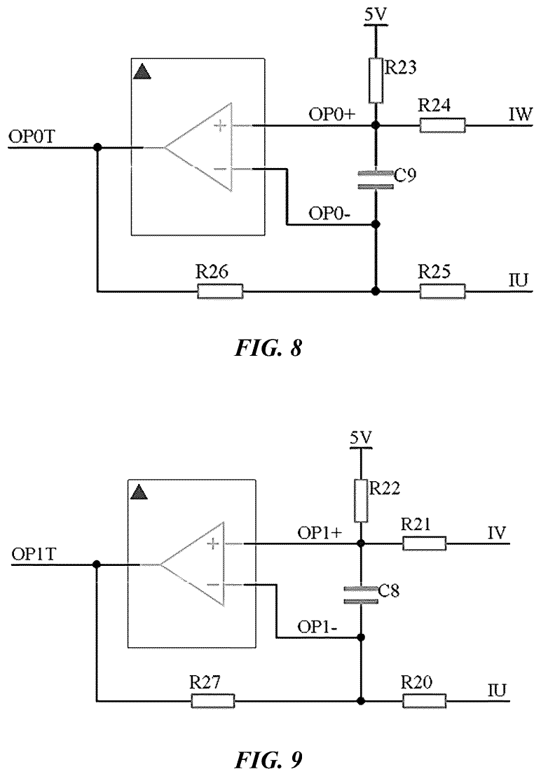

The first power supply line is provided with a current amplification unit. FIGS. 8 and 9, each depicts a circuit diagram of the current amplification unit of the first power supply line, according to an embodiment.

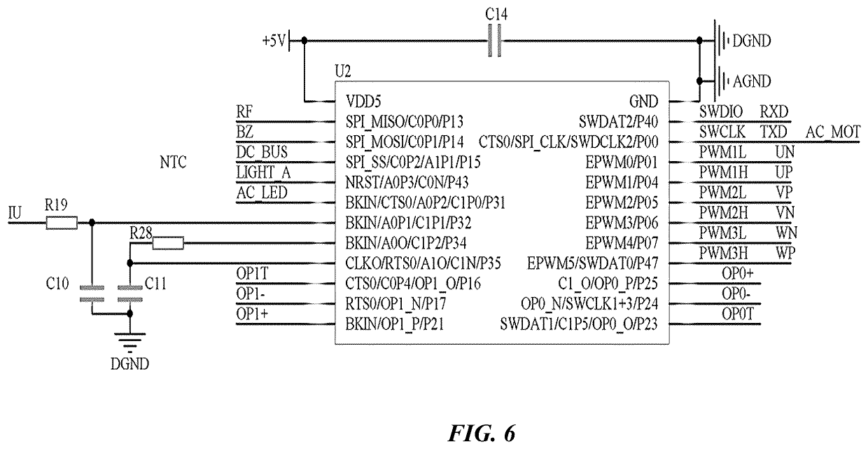

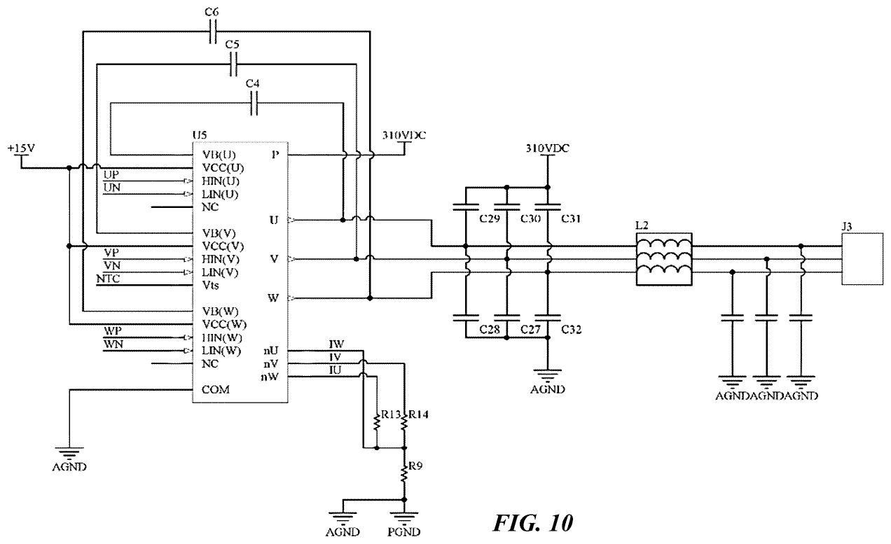

FIG. 6 depicts a circuit diagram of a first MCU. FIG. 10 depicts a circuit diagram of a motor driving unit. The first control unit includes a first MCU and a motor driving unit. The first MCU is connected with the motor driving unit. The motor driving unit is connected with the fan motor. Specifically, first MCU unit is connected at an output end thereof with an input end of the motor driving unit. The motor driving unit is connected at an output end thereof with the output end of the fan motor.

The first MCU analyzes the historical state information of the motor to obtain the present state information of the fan motor, and sends the present state information of the fan motor to the motor driving unit. The motor driving unit receives the present state information of the fan motor, obtains the present control signal of the fan motor according to the present state information of the fan motor, and sends the present control signal of the fan motor to the fan motor to control the present operating state of the fan motor. For example, the power of the fan motor is controlled, and the power of the fan motor is determined by the fan speed control switch of the fan.

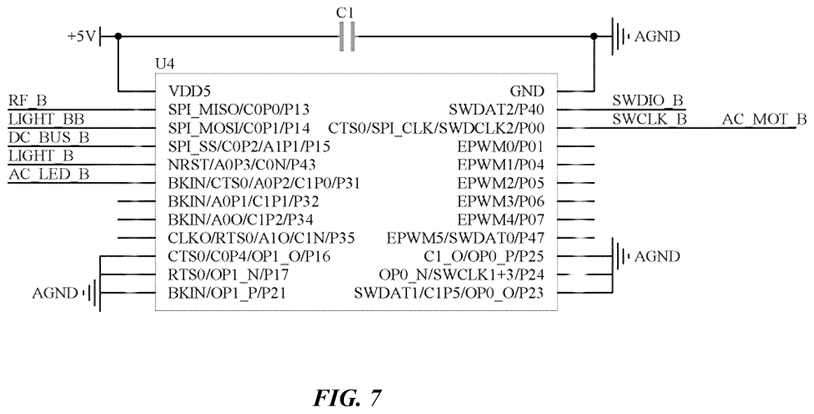

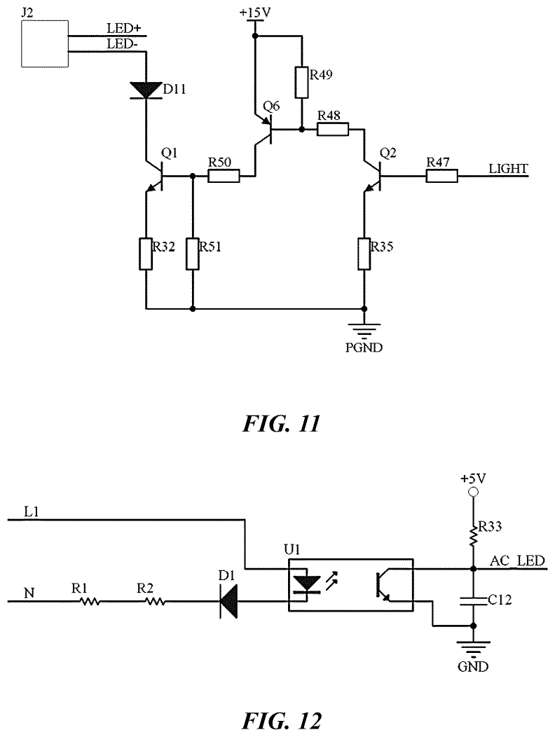

FIG. 7 depicts a circuit diagram of a second MCU. FIG. 11 depicts a circuit diagram of a light source driving unit. The second control unit includes a second MCU and a light source driving unit. The second MCU is connected with the light source driving unit. The light source driving unit is connected with the light source. Specifically, the output end of the second MCU unit is connected with the input end of the light source driving unit. The output end of the light source driving unit is connected with the light source.

The second MCU performs analysis according to the historical state information of the light source to obtain the present state information of the light source, and sends the present state information of the light source to the light source driving unit. The light source driving unit receives the present state information of the light source, obtains the current control signal of the light source according to the present state information of the light source, and sends the present control signal of the light source to the light source to control the present operating state of the light source, e.g., multi-light source control, RGB color control, lighting brightness level, timing control, scene mode, etc.

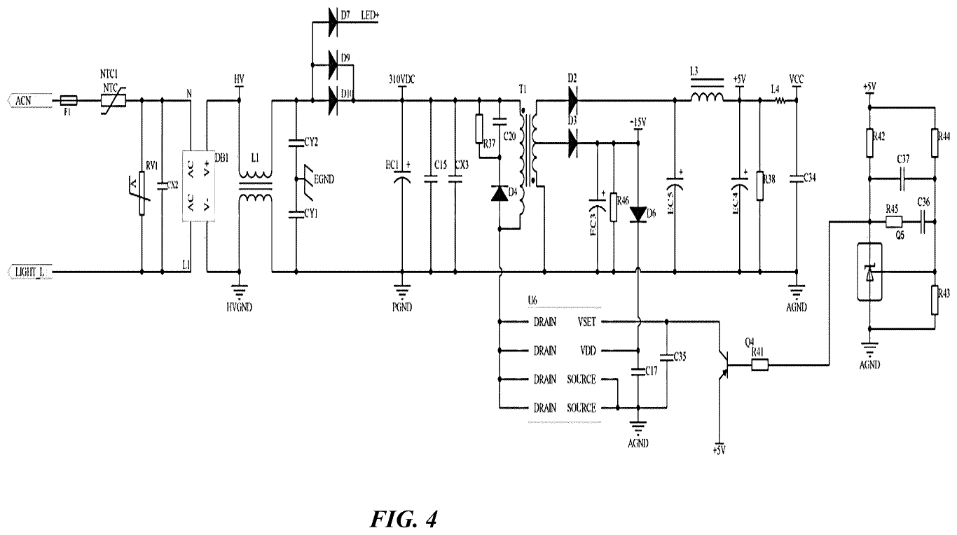

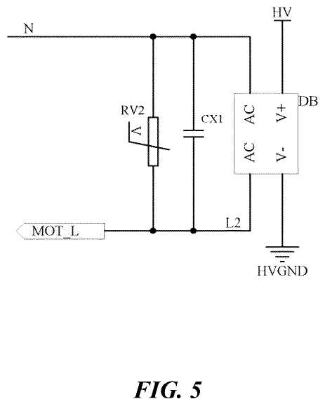

FIG. 4 depicts a circuit diagram of the second detection unit, the motor power supply unit and the light source power supply unit. FIG. 5 depicts a circuit diagram of the first detection unit. The first power supply line is provided with a motor power supply unit that is respectively connected with the first MCU and the motor driving unit. Specifically, the input end of the motor power supply unit is connected with the first detection unit. The output end of the motor power supply unit is connected with the first MCU and the motor driving unit respectively. The current input end of the motor power supply unit is connected with 120V alternating current (AC), which converts high-voltage alternating current into low-voltage direct current, and provides power for the first MCU and the motor driving unit through the low-voltage direct current.

According to some embodiments of the present disclosure, the second power supply line is provided with a light source power supply unit. The light source power supply unit is respectively connected with the second MCU and the light source driving unit. Specifically, the input end of the light source power supply unit is connected with the second detection unit, and the output end of the light source power supply unit is connected with the second MCU and the light source driving unit respectively. The current input end of the light source power supply unit is connected with 120V alternating current (AC), which converts high-voltage alternating current into low-voltage direct current, and provides power for the second MCU and the light source driving unit through the low-voltage direct current.

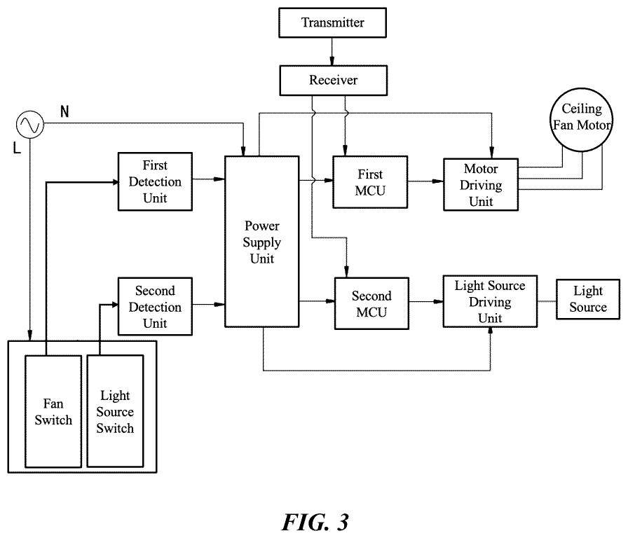

In some embodiments, referring to FIG. 3, the motor power supply unit and the light source power supply unit may be integrated together to form a single piece of power supply unit.

In some embodiments of the present disclosure, the first MCU and the second MCU are connected through a communication interface to realize data interaction between the first MCU and the second MCU, so as to coordinate the operating state of the fan motor and the operating state of the light source.

In some embodiments of the present disclosure, the control circuit further includes a first memory that is connected with the first MCU, and is configured to store information about an operating state of the fan motor. In one aspect, the first memory can be a local memory, and the information about the operating state of the fan motor is stored locally for easy reading. In another aspect, the first storage can be a cloud storage, and the information about the operating state of the fan motor is stored in an online cloud storage, thus saving local storage space. In an example, the power of the fan motor before the last turn-off state can be stored in the first memory. When the fan motor is started again, the power of the fan motor before the last turn-off state can be read from the first memory. The first MCU takes the power of the fan motor before the last turn-off state as the present power of the fan motor. The motor driving unit controls the present operating state of the fan motor according to the present power of the fan motor.

In some embodiments of the present disclosure, the control circuit further includes a second memory that is connected with the second MCU, and is configured to store information about an operating state of the light source. In one aspect, the second memory can be a local memory, and the information about the operating state of the light source is stored locally for easy reading. On the other hand, the second memory can be a cloud memory, which stores the operating state information of the light source in an online cloud storage, thus saving local storage space. For example, the previous operating state of the light source can be stored in the second memory. When the light source is activated again, the previous operating state of the light source is read from the second memory. The second MCU takes the previous operating state of the light source as the present operating state data of the light source. The light source driving unit controls the present operating state of the light source according to the present operating state data of the light source.

In some embodiments of the present disclosure, the control circuit further includes a receiver that is respectively connected with the first MCU and the second MCU. The receiver is further communicative connection with the transmitter, and is configured to receive data sent by the transmitter.

The receiver is connected with the first memory and the second memory.

The transmitter sends a motor activation instruction. The first MCU reads the power of the fan motor before the previous turn-off state through the first memory, obtains the present power of the fan motor according to the power of the fan motor before the previous turn-off state, and sends the present power of the fan motor to the motor driving unit. The motor driving unit obtains the present control signal of the fan motor according to the present power and controls the present operating state of the fan motor according to the present control signal. The transmitter sends a light source activation instruction. The second MCU reads the previous operating state of the light source through the memory. In particular, the second MCU reads the previous operating state of the light source through the second memory to obtain the present operating state data of the light source, and sends the present operating state data of the light source to the light source driving unit. The light source driving unit obtains the present control signal of the light source according to the present operating state data of the light source, and controls the present operating state of the light source according to the present control signal.

The first storage and the second storage are connected with the cloud server, and in such a case, the first storage and the second storage are cloud storage.

The cloud server reads the power before the previous turn-off state of the fan motor from the first memory, and sends the power. The first MCU receives the power before the previous turn-off state of the fan motor through the receiver, obtains the present power of the fan motor according to the power before the previous turn-off state of the fan motor, and sends the present power of the fan motor to the motor driving unit. The motor driving unit obtains the present control signal of the fan motor according to the present power of the fan motor, and controls the present power of the fan motor according to the present control signal. The cloud server reads the previous operating state of the light source from the second memory, and sends the previous operating state of the light source. The second MCU receives previous operating state of the light source through the receiver, obtains the present operating state of the light source according to the previous operating state of the light source, and sends the present operating state of the light source to the light source driving unit. The light source driving unit obtains the present control signal of the light source according to the present operating state of the light source, and controls the present operating state of the light source according to the present control signal.

Even if the power before the previous turn-off state of the fan motor was 0 (i.e., the fan motor was turned off), when the first detection unit detects that the first power supply line is switched from the disconnected state to the connected state (i.e., the fan switch is operated to turn on the fan), the first MCU can receive the first detection signal from the first detection unit, and the motor driving unit starts the fan motor and the fan begins to operate.

Similarly, even if the previous state of the light source was turn-off, when the second detection unit detects that the second power supply line is switched from the disconnected state to the connected state (i.e., the light source switch is operate to turn on light source), the second MCU unit receives the second detection signal from the second detection unit, and the light source driving unit activates the light source and the light source emits light.

Described above are several embodiments of the present disclosure. The present disclosure is not limited to the above-described embodiments. Any modification, equivalent substitution, improvement, made within the spirit and principle of this disclosure, as long as achieving the technical effect of the present disclosure by the same means, shall fall within the scope of protection of the present disclosure. The technical scheme and/or implementation can be modified and altered in various ways within the scope of protection of the present disclosure.

1. A control circuit for a ceiling fan having a light source, comprising:
a first detection unit, which is connected with a first power supply line of a fan motor of the ceiling fan with light source, and is configured to send a first detection signal in response to a detection that the first power supply line is switched from a disconnected state to a connected state;
a second detection unit, which is connected with a second power supply line of a light source of the ceiling fan with light source, and is configured to send a second detection signal in response to detection that the second power supply line is switched from a disconnected state to a connected state;
a first control unit, which is connected with the first detection unit and the fan motor respectively, and is configured to receive the first detection signal and to activate the fan motor; and
a second control unit, which is connected with the second detection unit and the light source respectively, and is configured to receive the second detection signal and to activate the light source.

2. The control circuit according to claim 1, wherein the first control unit comprises a first Microprocessor Control Unit (MCU) and a motor driving unit, the first MCU is connected with the motor driving unit, and the motor driving unit is connected with the fan motor.

3. The control circuit according to claim 2, wherein the second control unit comprises a second MCU unit and a light source driving unit, the second MCU unit is connected with the light source driving unit, and the light source driving unit is connected with the light source.

4. The control circuit according to claim 2, wherein the first power supply line is provided with a motor power supply unit that is respectively connected with the first MCU unit and the motor driving unit.

5. The control circuit according to claim 3, wherein the second power supply line is provided with a light source power supply unit that is respectively connected with the second MCU unit and the light source driving unit.

6. The control circuit according to claim 3, wherein the first MCU unit and the second MCU unit are connected through a communication interface.

7. The control circuit according to claim 3, wherein the control circuit further comprises a receiver that is connected with the first MCU unit and the second MCU unit respectively, and the receiver is further in communicative connection with a transmitter, and is configured to receive data sent by the transmitter.

8. The control circuit according to claim 2, further comprising a first memory that is connected with the first MCU unit and is configured to store information about an operating state of the fan motor.

9. The control circuit according to claim 3, further comprising a second memory that is connected with the second MCU unit and is configured to store information about an operating state of the light source.

10. A ceiling fan with light source, comprising:
a fan switch,
a light source switch,
a fan motor, a light source, and
a control circuit comprising:
a first detection unit, which is connected with a first power supply line of a fan motor of the ceiling fan with light source, and is configured to send a first detection signal in response to a detection that the first power supply line is switched from a disconnected state to a connected state;
a second detection unit, which is connected with a second power supply line of a light source of the ceiling fan with light source, and is configured to send a second detection signal in response to detection that the second power supply line is switched from a disconnected state to a connected state;
a first control unit, which is connected with the first detection unit and the fan motor respectively, and is configured to receive the first detection signal and to activate the fan motor; and
a second control unit, which is connected with the second detection unit and the light source respectively, and is configured to receive the second detection signal and to activate the light source;
wherein the fan switch is connected with the first power supply line of the control circuit, the light source switch is connected with the second power supply line of the control circuit, the fan motor is connected with the first control unit of the control circuit, and the light source is connected with the second control unit of the control circuit.

11. The ceiling fan according to claim 10, wherein the first control unit comprises a first Microprocessor Control Unit (MCU) and a motor driving unit, the first MCU is connected with the motor driving unit, and the motor driving unit is connected with the fan motor.

12. The ceiling fan according to claim 11, wherein the second control unit comprises a second MCU unit and a light source driving unit, the second MCU unit is connected with the light source driving unit, and the light source driving unit is connected with the light source.

13. The ceiling fan according to claim 11, wherein the first power supply line is provided with a motor power supply unit that is respectively connected with the first MCU unit and the motor driving unit.

14. The ceiling fan according to claim 12, wherein the second power supply line is provided with a light source power supply unit that is respectively connected with the second MCU unit and the light source driving unit.

15. The ceiling fan according to claim 12, wherein the first MCU unit and the second MCU unit are connected through a communication interface.

16. The ceiling fan according to claim 12, wherein the control circuit further comprises a receiver that is connected with the first MCU unit and the second MCU unit respectively, and the receiver is further in communicative connection with a transmitter, and is configured to receive data sent by the transmitter.

17. The ceiling fan according to claim 11, further comprising a first memory that is connected with the first MCU unit and is configured to store information about an operating state of the fan motor.

18. The ceiling fan according to claim 12, further comprising a second memory that is connected with the second MCU unit and is configured to store information about an operating state of the light source.
